(19) United States
(12) Patent Application Publication
(10) Pub. No.: US 2012/0170426 A1
(43) Pub. Date: Jul. 5, 2012

(54) Analogue electronic timepiece

(76) Inventors: Keishi Honmura, Chiba-shi (JP); Saburo Manaka, Chiba-shi (JP); Kenji Ogasawara, Chiba-shi (JP); Kazumi Sakumoto, Chiba-shi (JP); Hiroshi Shimizu, Chiba-shi (JP); Kosuke Yamamoto, Chiba-shi (JP)

(21) Appl. No.: 13/374,141

(22) Filed: Dec. 13, 2011

(30) Foreign Application Priority Data
Dec. 29, 2010 (JP) 2010-294478
Sep. 8, 2011 (JP) 2011-196344

(51) Int. Cl. G04C 3/00

(52) U.S. Cl. 368/76

(57) ABSTRACT

A stepping motor for driving time hands, a stepping motor for driving a calendar, and a stepping motor for driving chronograph hands are all housed in a bottom plate of a movement of an analogue electronic timepiece. The stepping motor for driving chronograph hands is connected to a battery can via a battery pressing piece. The stepping motor for driving chronograph hands is arranged such that a larger amount of external magnetic field passes that stepping motor than the other stepping motors via the battery can and the battery pressing piece. The rotational drive of the stepping motor for driving chronograph hands can be made stable even under the presence of the external magnetic field by setting a drive force of the stepping motor for driving chronograph hands larger than the drive forces of the other stepping motors.

### BACKGROUND OF THE INVENTION

1. Field of the Invention

The present invention relates to an analogue electronic timepiece which rotatably drives an indication member such as a hand by a motor, and more particularly to an analogue electronic timepiece provided with a plurality of motors for driving a plurality of indication members.

2. Description of the Related Art

Conventionally, as represented by an analogue electronic timepiece which indicates time, date and the like by indication members such as hands, calendars, a chronograph timepiece which indicates a measured time by chronograph hands which constitute indication members or the like, an analogue electronic timepiece which rotatably drives a plurality of indication members such as hands, a calendar or chronograph hands using a plurality of motors has been used.

FIGS. 7A and 7B are views showing a coil block 304 of a stepping motor which has been conventionally used in an analogue electronic timepiece, wherein FIG. 7A is a plan view and FIG. 7B is a front view. In FIG. 7A and FIG. 7B, the coil block 304 includes a magnetic core 208 and a coil 209 for driving a motor which is wound around the magnetic core 208. The coil block 304 is used in a state where the coil block 304 is fastened to a bottom plate of an analogue electronic timepiece movement together with a stator which constitutes a magnetic circuit with the coil block 30 by screws which are inserted into screw holes 401.

In JP-A-9-105786 (patent document 1), there is disclosed the invention where in an analogue electronic timepiece which is provided with a plurality of converters such as the above-mentioned stepping motor and a power generator, the analogue electronic timepiece can perform functions even when a magnetic field affects the analogue electronic timepiece.

With respect to the invention described in patent document 1, two coils are arranged substantially orthogonal to each other for reducing the mutual influence between two magnetic circuits.

As a method by which the analogue electronic timepiece is minimally influenced by a magnetic field, there have been generally used a method where the tolerance of magnetic saturation is increased by increasing a cross-sectional area of a coil magnetic core, a method where an analogue electronic timepiece is driven in a state where a magnetic field exists using a drive pulse having the larger energy than the energy of a drive pulse at the time of applying no magnetic field or the like (for example, a correction drive pulse).

However, when the analogue electronic timepiece includes two or more coils, there exists a drawback that the large restriction is imposed on the orthogonal arrangement of the respective magnetic circuits in the inside of the movement of the analogue electronic timepiece in terms of layout.

Also considered is a method where cross-sectional areas of coil magnetic cores of all stepping motors are enlarged. This method, however, has a drawback that a volume which the motor occupies is increased.

Also considered is a method where magnetic shielding is applied to an analogue electronic timepiece by magnetically shielding respective motors with a magnetic material. This method, however, has a drawback that when a dedicated member for magnetic shielding is arranged in a limited space in the analogue electronic timepiece, it is difficult to realize the miniaturization of the timepiece.

### SUMMARY OF THE INVENTION

It is an aspect of the present application to provide an analogue electronic timepiece which can reduce the influence of a magnetic field exerted on motors with the simple constitution without using a special dedicated member.

According to the aspect of the present application, there is provided an analogue electronic timepiece where a plurality of motors which rotatably drive a plurality of indication members are mounted on a movement, wherein the timepiece includes a magnetic member through which an external magnetic field passes besides the plurality of motors, and a specified motor is arranged such that a larger amount of external magnetic field passes through the specified motor than another motor via the magnetic member, and a drive force of the specified motor is set larger than a drive force of another motor.

According to the analogue electronic timepiece of the present application, it is possible to reduce the influence of a magnetic field exerted on the motor with the simple constitution without using a special dedicated member.

### BRIEF EXPLANATION OF THE DRAWINGS

FIG. 1 is a block diagram of an analogue electronic timepiece according to an embodiment of the present invention;

FIG. 2 is a basic constitutional view of a stepping motor used in the analogue electronic timepiece according to the embodiment of the present invention;

FIG. 3 is a plan view showing a movement of an analogue electronic timepiece according to a first embodiment of the present invention;

FIGS. 4A and 4B are partial constitutional views of a stepping motor used in the analogue electronic timepiece according to the first embodiment of the present invention;

FIGS. 5A and 5B are partial constitutional views of a stepping motor used in an analogue electronic timepiece according to a second embodiment of the present invention;

FIG. 6 is a plan view showing a movement of an analogue electronic timepiece according to a third embodiment of the present invention;

FIGS. 7A and 7B are partial constitutional views of a stepping motor used in a conventional analogue electronic timepiece;

FIGS. 8A and 8B are partial constitutional views of a stepping motor used in an analogue electronic timepiece according to a fourth embodiment of the present invention;

FIG. 9 is a side view showing a rotor of a stepping motor used in a conventional analogue electronic timepiece;

FIG. 10 is a side view showing a rotor of a stepping motor used in an analogue electronic timepiece according to a fifth embodiment of the present invention;

FIG. 11 is a side view showing a rotor of a stepping motor used in an analogue electronic timepiece according to a sixth embodiment of the present invention;

FIG. 12 is a side view showing a rotor of a stepping motor used in an analogue electronic timepiece according to a seventh embodiment of the present invention;

FIG. 13 is a partial plan view showing a stator of a stepping motor used in a conventional analogue electronic timepiece;

FIG. 14 is a partial plan view showing a stator of a stepping motor used in an analogue electronic timepiece according to an eighth embodiment of the present invention; and

FIG. 15 is a partial plan view showing a stator of a stepping motor used in an analogue electronic timepiece according to a ninth embodiment of the present invention.

### DESCRIPTION OF THE PREFERRED EMBODIMENTS

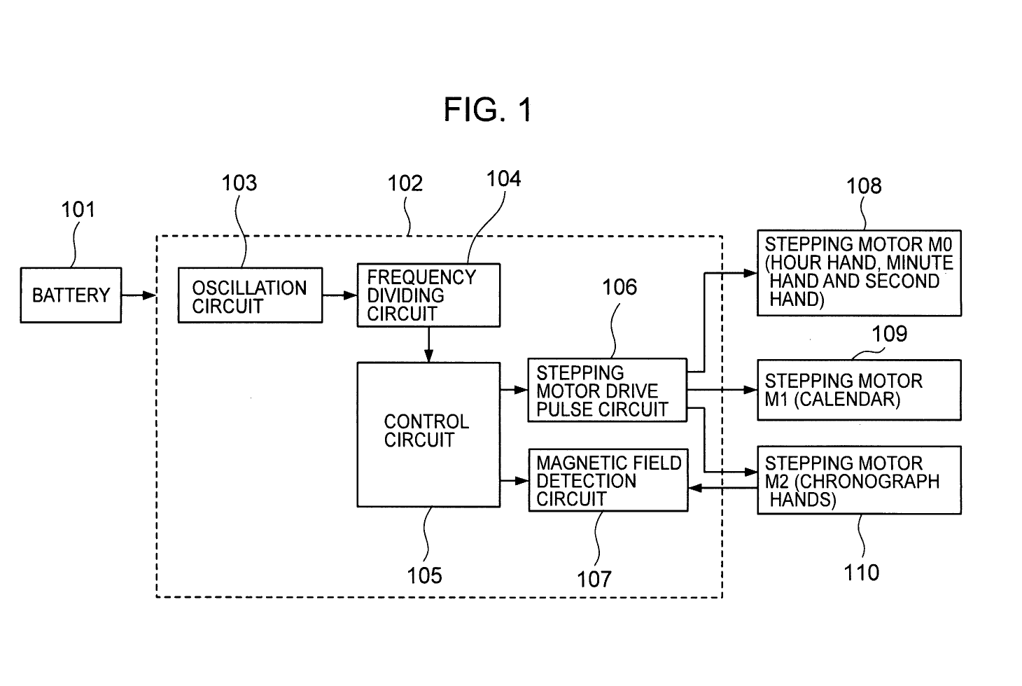

An analogue electronic timepiece according to an embodiment of the present invention is explained hereinafter. In respective drawings, identical parts are given same symbols. Further, in FIG. 1, a manipulation part which instructs start and stop of time measurement and the like is omitted.

FIG. 1 is a block diagram of the analogue electronic timepiece according to the embodiment of the present invention, and shows an example where the analogue electronic timepiece is a chronograph timepiece. The block diagram is used in common by respective embodiments described later.

In FIG. 1, the analogue electronic timepiece includes a plurality of (three in this embodiment) stepping motors 108, 109, 110 which are rotatably driven by a stepping motor control circuit 102, and a battery 101 which functions as a power source for supplying drive power to circuit elements such as the stepping motor control circuit 102 and the stepping motors 108 to 110.

The stepping motor 108 is a stepping motor for rotatably driving a hand for indicating time (not shown in the drawing). The stepping motor 109 is a stepping motor for rotatably driving a calendar mechanism (not shown in the drawing). Further, the stepping motor 110 is a stepping motor for rotatably driving a chronograph hand for indicating measured time (not shown in the drawing).

The stepping motor control circuit 102 includes an oscillation circuit 103 which generates a signal of predetermined frequency, a frequency dividing circuit 104 which generates a clock signal which becomes the reference for time measurement by dividing the frequency of a signal generated by the oscillation circuit 103, a control circuit 105 which performs controls such as a control of respective electronic circuit elements which constitute the electronic timepiece and a change control of a drive pulse, a stepping motor drive pulse circuit 106 which selectively outputs drive pulses for rotatably driving the stepping motors 108 to 110 based on control signals from the control circuit 105, and a magnetic field detection circuit 107 which detects an external magnetic field.

The stepping motor control circuit 102 is constituted of one integrated circuit (IC) and a crystal oscillator (not shown in the drawing) which forms the oscillation circuit 103.

Here, the oscillation circuit 103 and the frequency dividing circuit 104 constitute a signal generation means.

Further, the control circuit 105 constitutes a control means, and the magnetic field detection circuit 107 constitutes a magnetic field detection means.

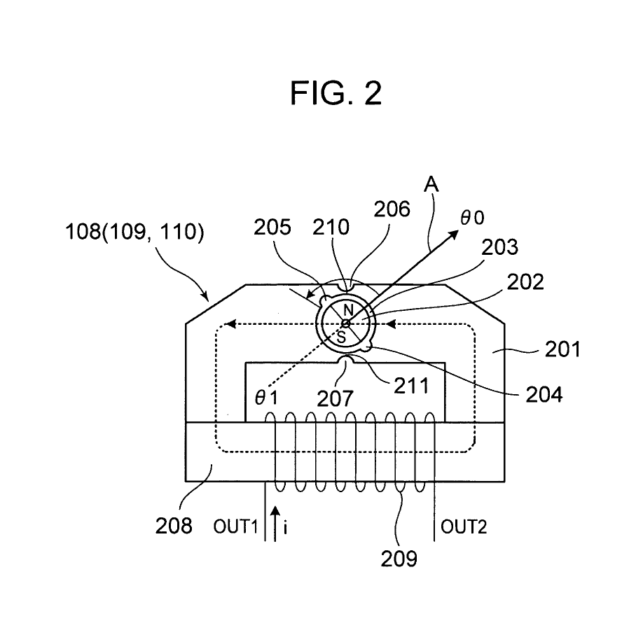

FIG. 2 is a basic constitutional view showing the constitution of the stepping motor used in the embodiment of the present invention for explaining the principle of the stepping motor, and is shared in common by the stepping motors 108 to 110. FIG. 2 shows an example of a 2-pole PM-type stepping motor which is used in an analogue electronic timepiece in general.

In FIG. 2, the stepping motor 108 (hereinafter, other stepping motors 109, 110 having the same basic constitution although the stepping motor 108 is described as a representative example) includes a stator 201 having a rotor housing through hole 203, a rotor 202 which is rotatably arranged in the rotor housing through hole 203, a magnetic core 208 which is joined to the stator 201, and a coil 209 for driving stepping motor which is wound around the magnetic core 208. When the stepping motor 108 is used in the analogue electronic timepiece, the stator 201 and the magnetic core 208 are fixed to a bottom plate (not shown in the drawing) by screws (not shown in the drawings) and joined to each other. The coil 209 has a first terminal OUT1 and a second terminal OUT2.

The rotor 202 is magnetized to two poles (S pole and N pole). A plurality of (two in this embodiment) notched portions (outer notches) 206, 207 are formed on outer edge portions of the stator 201 formed using a magnetic material at positions opposite to each other with the rotor housing through hole 203 sandwiched therebetween. Saturable parts 210, 211 are formed between the respective outer notches 206,207 and the rotor housing through hole 203.

The saturable parts 210, 211 are configured not to be magnetically saturated by a magnetic flux of the rotor 202, but are configured to be magnetically saturated when the coil 209 is excited thus increasing magnetic resistance. The rotor housing through hole 203 is formed into a circular hole shape where a plurality of (two in this embodiment) semicircular notched portions (inner notches) 204, 205 are integrally formed with the through hole having a circular profile at positions opposite to each other.

The notched portions 204, 205 constitute positioning portions for deciding a stop position of the rotor 202. In a state where the coil 209 is not energized, as shown in FIG. 2, the rotor 202 is stably stopped at a position corresponding to the positioning portion, that is, at a position where a magnetic pole axis A of the rotor 202 is orthogonal to a line segment which connects the notched portions 204, 205 (angle θ0 position).

Here, when a drive pulse formed of a square wave and having first polarity (for example, a positive pole on a first terminal OUT1 side and a negative pole on a second terminal OUT2 side) is supplied between terminals OUT1 and OUT2 of the coil 209 from the stepping motor drive pulse circuit 106 so that an electric current i flows in the direction indicated by an arrow in FIG. 2, a magnetic flux is generated in the magnetic core 208 and the stator 201 in an arrowed direction indicated by a broken line. Accordingly, the saturable portions 210, 211 are saturated so that the magnetic resistance is increased. Thereafter, due to an interaction between a magnetic pole generated in the stator 201 and a magnetic pole of the rotor 202, the rotor 202 is rotated in the direction indicated by an arrow in FIG. 2 by 180 degrees, and is stably stopped at an angle θ1 position. Here, the rotation direction (the counter clockwise direction in FIG. 2) for performing a usual operation (a hand moving operation and a calendar advancing operation since the timepiece is an analogue electronic timepiece in this embodiment) by rotatably driving the stepping motor 108 is assumed as the positive direction, and the direction (clockwise direction) opposite to such a direction is assumed as the reverse direction.

Next, when a drive pulse formed of a square wave and having second polarity different from the first polarity (a negative pole on the first terminal OUT1 side and a positive pole on the second terminal OUT2 side so as to have polarity opposite to the polarity in the above-mentioned driving) is supplied between the terminals OUT1 and OUT2 of the coil 209 from the stepping motor drive pulse circuit 106 so that an electric current i flows in the direction opposite to the direction indicated by an arrow in FIG. 2, a magnetic flux is generated in the stator 201 in the direction opposite to the direction indicated by an arrow of a broken line. Accordingly, the saturable portions 210, 211 are firstly saturated and, thereafter, due to an interaction between a magnetic pole generated in the stator 201 and a magnetic pole of the rotor 202, the rotor 202 is rotated in the same direction as the above-mentioned direction (normal direction) by 180 degrees, and the magnetic pole axis A is stably stopped at an angle θ0 position.

Thereafter, by supplying drive signals (alternating signal) having different polarities to the coil 209 in this manner, the above-mentioned operation is repeatedly performed so that the rotor 202 can be continuously rotated in the direction indicated by an arrow by 180 degrees for each time.

In this embodiment, as a drive pulse, a plurality of drive pulses having drive energies different from each other are used as described later. When an external magnetic field having predetermined intensity or more is present, the stepping motor 110 which constitutes a specified motor is configured to be driven using a predetermined drive pulse having energy larger than energies of drive pulses for the stepping motors 108, 109 which constitute other motors. Further, the stepping motor 110 is configured to be driven using a predetermined drive pulse having energy larger than energy when an external magnetic field is not present. In this manner, a drive force of the specified stepping motor 110 is set larger than drive forces of other stepping motors 108, 109 also in terms of driving.

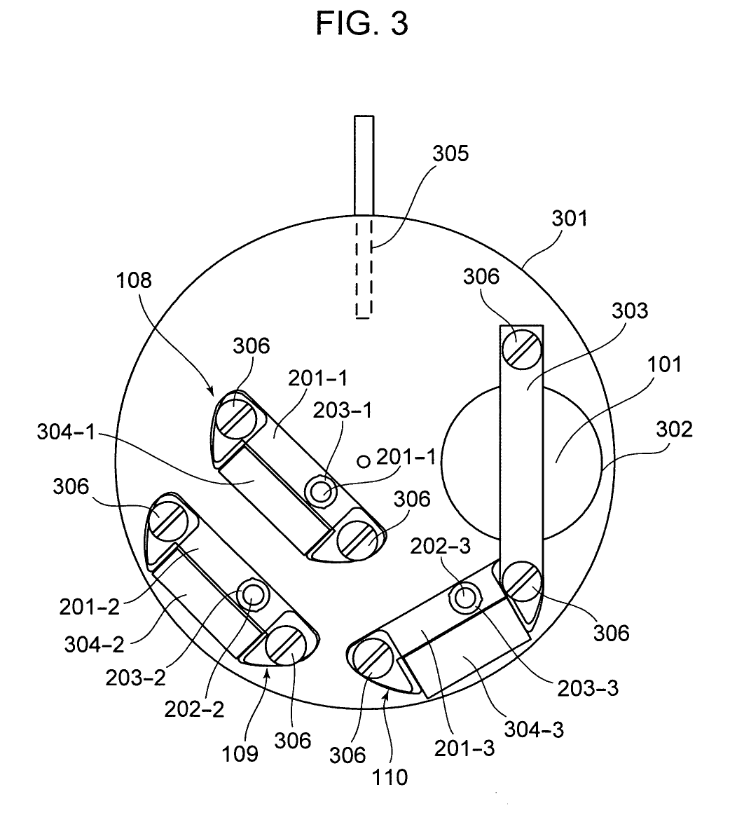

FIG. 3 is a plan view showing the inside of an analogue electronic timepiece according to the first embodiment of the present invention.

In FIG. 3, numeral 301 indicates a bottom plate of a movement of the analogue electronic timepiece, numeral 302 indicates a battery can of the battery 101, numeral 303 indicates a battery pressing piece, and numeral 305 indicates a winding stem. The battery pressing piece 303 is fixed to the bottom plate 301 by a screw 306 so that the battery 101 is fixed to the bottom plate 301 by the battery pressing piece 303 thus preventing the removal of the battery 101 from the bottom plate 301.

The battery can 302 and the battery pressing piece 303 are made of a magnetic material (for example, an iron-based or stainless-steel-based magnetic material), and constitute magnetic members respectively.

The stepping motor 108 for driving time hands includes a coil block 304-1, a stator 201-1 having a rotor housing through hole 203-1, and a rotor 202-1 which is rotatably arranged in the inside of the rotor housing through hole 203-1. The stepping motor 109 for driving a calendar includes a coil block 304-2, a stator 201-2 having a rotor housing through hole 203-2, and a rotor 202-2 which is rotatably arranged in the inside of the rotor housing through hole 203-2. The stepping motor 110 for driving a chronograph hand includes a coil block 304-3, a stator 201-3 having a rotor housing through hole 203-3, and a rotor 202-3 which is rotatably arranged in the inside of the rotor housing through hole 203-3. The respective stepping motors 108 to 109 are fixed in the inside of the bottom plate 301 by the screw 306.

The stepping motor 110 which constitutes the specified motor is connected to the battery can 302 via the battery pressing piece 303. Further, the stepping motor 110 is arranged at a position closer to the battery can 302 than the stepping motors 108, 109 which constitute other motors (motors other than the specified motor) are.

As the specified motor, the motor other than the motors which are always in a rotary operation such as the motor for driving the time hand (the stepping motor 109 for driving the calendar or the stepping motor 110 for driving the chronograph hand in this embodiment) can be selected. Further, as the motor which is selected as the above-mentioned other motors, at least the motor which always performs a rotary operation (the stepping motor 108 for driving the time hand in this embodiment) is included.

Due to such a constitution, an external magnetic field can be easily collected at the battery can 302 which is formed using a magnetic material and has a large area, and an external magnetic flux which passes the battery can 302 flows into the stepping motor 110 via the battery pressing piece 303. Accordingly, an external magnetic flux which flows into other stepping motors 108, 109 can be made small and hence, the influence which the external magnetic field exerts on other stepping motors 108, 109 can be made small.

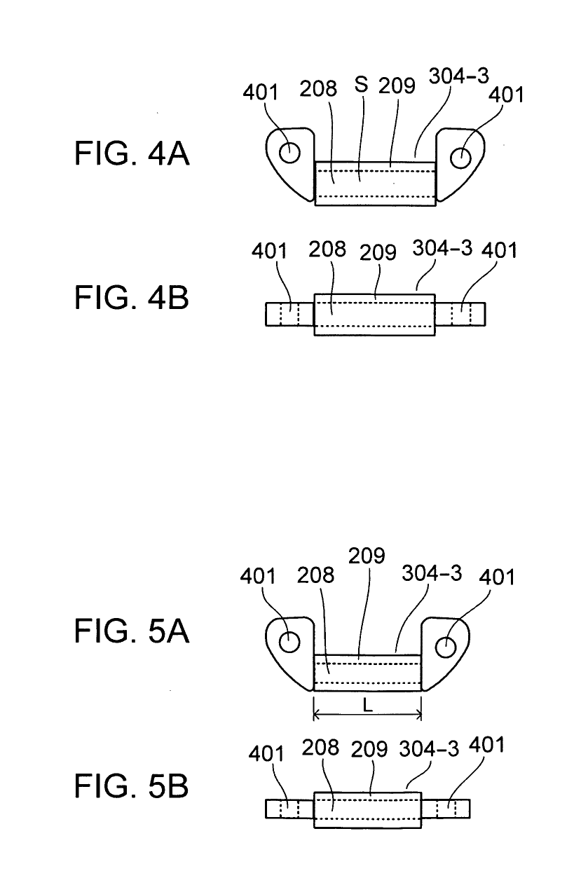

FIGS. 4A and 4B are partial constitutional views of the stepping motor 110, and shows the coil block 304-3 of the stepping motor 110. In FIGS. 4A and 4B, by setting a cross-sectional area S of the magnetic core 208 of the stepping motor 110 larger than cross-sectional areas S of magnetic cores of other stepping motors 108, 109, the magnetic resistance of the magnetic core 208 can be made small thus increasing a drive force of the stepping motor 110. Further, by increasing a level of a saturation magnetic flux by increasing the cross-sectional area S of the magnetic core 208, a large drive magnetic flux is allowed to pass through the magnetic core 208 thus increasing a drive force in a magnetic field.

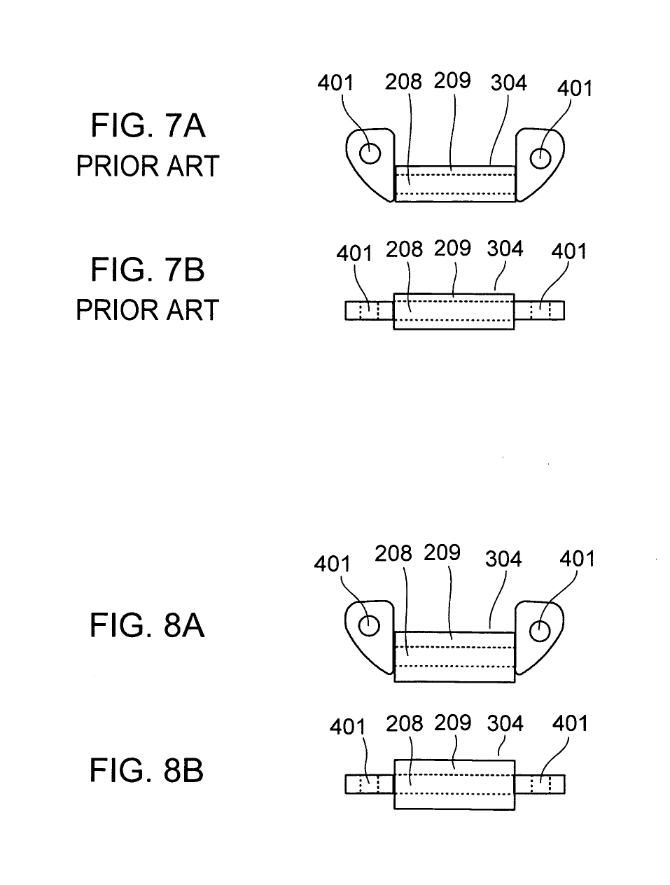

The magnetic cores 208 of other stepping motors 108, 109 are equal to a magnetic core 208 shown in FIGS. 7A and 7B, wherein the cross-sectional areas of the magnetic cores 208 are set smaller than a cross-sectional area of the magnetic core 208 of the stepping motor 110.

In this manner, a drive force of the specified stepping motor 110 is set larger than drive forces of other stepping motors 108, 109 also in terms of the structure of the motor.

In performing the indication of time by counting time, the oscillation circuit 103 generates a reference clock signal of predetermined frequency, and a frequency dividing circuit 104 divides the frequency of the signal generated by the oscillation circuit 103 thus outputting a time signal which becomes the reference at the time of counting time to the control circuit 105.

The control circuit 105 performs a time measurement operation by counting the clock signals, and outputs control signals to the stepping motor drive pulse circuit 106 so as to drive the time hands (hour, minute and second hands) for every predetermined timing. The stepping motor drive pulse circuit 106 always rotatably drives the stepping motor 108 for driving time hands in response to the control signals. The stepping motor 108 rotatably drives the time hands not shown in the drawing so that a current time is always indicated by the time hands.

When the control circuit 105 determines that the time at which it is necessary to change the indication of date has arrived, the control circuit 105 outputs a control signal to the stepping motor 109 so as to rotatably drive the calendar mechanism (not shown in the drawing). The stepping motor 109 rotatably drives the calendar mechanism only for a fixed time in response to the control signal thus changing the indicated date to next day.

When the control circuit 105 determines that a time measurement start manipulation is performed by a manipulation part (not shown in the drawing), the control circuit 105 starts a time measurement operation, and outputs a control signal to the stepping motor drive pulse circuit 106 for every predetermined timing so as to indicate measured time. The stepping motor drive pulse circuit 106 rotatably drives the stepping motor 110 in response to the control signal. Due to such an operation, the stepping motor 110 rotatably drives chronograph hands thus allowing the chronograph hands to indicate the measuring time.

When the control circuit 105 determines that a time measurement stop manipulation is performed by the manipulation part (not shown in the drawing), the control part 105 stops the time measurement operation and outputs a control signal to the stepping motor drive pulse circuit 106 so as to stop the driving of the stepping motor 110. The stepping motor drive pulse circuit 106 stops the rotary driving of the stepping motor 110 in response to the control signal. Due to such an operation, the stepping motor 110 rotatably drives the chronograph hands only during a period where the time measurement is performed, and the chronograph hands are stopped at positions where the chronograph hands indicate the measured time.

On the other hand, the magnetic field detection circuit 107 detects a magnetic field outside the analogue electronic timepiece during a time measurement operation. When the control circuit 105 determines that the magnetic field detection circuit 107 detects an external magnetic field of predetermined intensity or more, the control circuit 105 outputs a control signal to the stepping motor drive pulse circuit 106 so as to make the stepping motor drive pulse circuit 106 drive the stepping motor 110 by changing a drive pulse to a predetermined drive pulse having larger drive energy than a main drive pulse when the external magnetic field of predetermined intensity or more is not detected (for example, a correction drive pulse having larger drive energy than the main drive pulse).

The stepping motor drive pulse circuit 106, in response to the control signal, rotatably drives the stepping motor 110 based on the predetermined drive pulse. Accordingly, even when an external magnetic field of predetermined intensity or more is generated, it is possible to surely rotatably drive the stepping motor 110 by increasing a drive force of the stepping motor 110. In this case, the motor which is driven by a drive pulse having large energy is not the motor which is always driven such as the stepping motor 108 for driving time hands but is the motor which is driven for a short time such as a measurement time or a calendar mechanism drive time and hence, the increase of the power consumption can be suppressed to a small value.

The energy of the drive pulse can be increased only when the magnetic field detection circuit 107 detects an external magnetic field of predetermined intensity or more and hence, the increase of power consumption can be suppressed to a small value. However, it is not always necessary to provide the magnetic field detection circuit 107, and the stepping motor 110 may be always driven with a drive pulse of large energy when the stepping motor 110 is rotatably driven. Due to such a constitution, the constitution of the analogue electronic timepiece can be simplified.

Further, to increase a drive force of the stepping motor 110, this embodiment uses the constitution which increases drive energy and the constitution which makes the magnetic resistance of the magnetic core 208 small. However, the analogue electronic timepiece may be configured to use only at least one of them.

Further, although the battery can 302, the battery pressing piece 303 and the specified motor 110 are directly connected with each other, the battery can 302, the battery pressing piece 303 and the specified motor 110 may be indirectly connected with each other with a space therebetween.

As has been explained heretofore, in the analogue electronic timepiece according to the first embodiment of the present invention, the plurality of motors (the stepping motor 108 for driving time hands, the stepping motor 109 for driving calendar, the stepping motor 110 for driving chronograph hands) are mounted on the bottom plate 301 of the movement, and the stepping motor 110 is connected to the battery can 302 via the battery pressing piece 303. By arranging the stepping motor 110 such that a larger amount of magnetic field passes the stepping motor 110 than other stepping motors 108, 109 via the battery can 302 and the battery pressing piece 303, the influence of the external magnetic field exerted on other stepping motors 108, 109 can be reduced and, at the same time, the rotational drive of the stepping motor 110 can be made stable even under the presence of the external magnetic field by setting a drive force of the stepping motor 110 larger than drive forces of the stepping motors 108, 109.

That is, the analogue electronic timepiece of this embodiment is characterized in that, in the analogue electronic timepiece where a plurality of stepping motors 108, 109, 110 for rotatably driving a plurality of indication members are mounted on the bottom plate 301 of the movement, the analogue electronic timepiece includes the magnetic members (for example, the battery can 302, the battery pressing piece 303) through which an external magnetic field passes besides the plurality of motors 108 to 110 so that the specified motor 110 is arranged such that a larger amount of external magnetic field passes the through the specified motor 110 compared to other motors 108, 109 whereby the specified motor 110 generates a stronger drive force than other motors 108, 109.

Here, the drive energy of the specified motor 110 may be set larger than drive energies of other motors 108, 109.

Further, the analogue electronic timepiece may include the magnetic field detection circuit 107 which detects a magnetic field and a control means which performs a control such that the drive energy of the specified motor 110 is set larger than drive energies of other motors 108, 109 when the magnetic field detection circuit 107 detects a magnetic field of predetermined intensity or more.

Further, the respective motors 108 to 110 may include a magnetic core 208, a coil 209 which is wound around the magnetic core 208, and a rotor 202 which is rotated based on a magnetic field generated with the supply of an electric current to the coil 209, and a drive force of the specified motor 110 may be increased by setting the magnetic resistance of the magnetic core 208 of the specified motor 110 smaller than the magnetic resistances of the magnetic cores 208 of other motors 108, 109. Here, the magnetic resistance of the magnetic core 208 of the specified motor 110 may be set smaller than the magnetic resistances of the magnetic cores 208 of other motors 108, 109 by setting a cross-sectional area S of the core 208 of the specified motor 110 larger than cross-sectional areas S of the cores 208 of other motors 108, 109.

As described above, according to the analogue electronic timepiece of the present invention, it is possible to reduce the influence of an external magnetic field exerted on the motor with the simple constitution without using the special dedicated member.

Further, in the analogue electronic timepiece having the plurality of motors, in place of providing the complete countermeasure against a magnetic field to the respective motors, a drive force of the specified motor is strengthened, the member which is liable to be influenced by the magnetism such as the battery can 302 and the specified motor are set closer to each other in terms of a magnetic circuit than other motors thus realizing a magnetic shield which makes other motors hardly influenced by a magnetic field.

Further, in the analogue electronic timepiece which includes a plurality of motors, the present invention can acquire advantageous effects such as the suppression of large-sizing of the analogue electronic timepiece and stable and sure movement of hands in an external magnetic field.

FIGS. 5A and 5B are partial constitutional views of a specified stepping motor 110 used in the second embodiment of the present invention. Although a cross-sectional area S of the magnetic core 208 is increased for decreasing the magnetic resistance of the magnetic core 208 in the first embodiment, in the second embodiment, a length L of the magnetic core 208 is set shorter than lengths of the magnetic cores 208 of other stepping motors 108, 109. The other constitutions of the second embodiment are substantially equal to the corresponding constitutions of the first embodiment. This embodiment can acquire the substantially equal advantageous effects as the first embodiment.

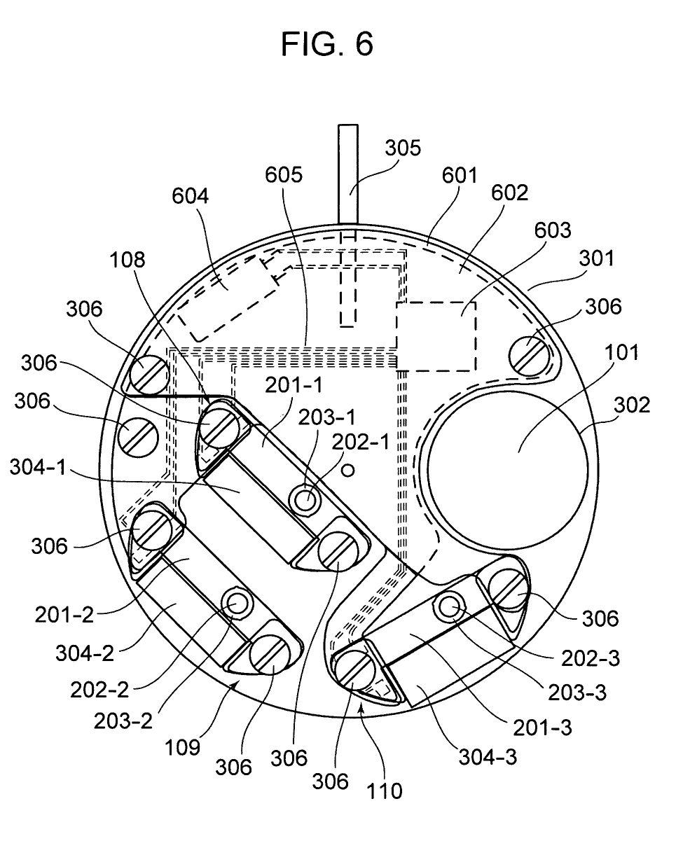

FIG. 6 is a plan view showing the inside of an analogue electronic timepiece according to the third embodiment of the present invention.

In FIG. 6, in a bottom plate 301 of a movement of the analogue electronic timepiece, besides a battery 101, a stepping motor 108 for driving time hands, a stepping motor 109 for driving a calendar and a stepping motor 110 for driving chronograph hands, an insulating printed circuit board 602 on which circuit elements of the analogue electronic timepiece are mounted and a circuit pressing piece 601 which is mounted on the bottom plate 301 for preventing the removal of the printed circuit board 602 from the bottom plate 301 are provided. The circuit pressing piece 601 is made of a magnetic material in the same manner as the battery can 302, and constitutes a magnetic body member.

On the printed circuit board 602, an integrated circuit 603 which constitutes a stepping motor control circuit 102 and a crystal oscillator 604 which constitutes an oscillation circuit 103 are mounted, and the integrated circuit 603 and the crystal oscillator 604 are electrically connected with the stepping motors 108 to 110 by a wiring pattern 605.

The circuit pressing piece 601 and the printed circuit board 602 are fixed to the bottom plate 301 using screws 306 in the same manner as the stepping motors 108, 109.

The stepping motor 110 which constitutes the specified motor is connected to the circuit pressing piece 601. Further, the stepping motor 110 is arranged at a position closer to the battery can 302 and the circuit pressing piece 601 than the stepping motors 108, 109 which constitute other motors are.

A drive force of the stepping motor 110 is, in the same manner as the above-mentioned respective embodiments, set larger than drive forces of other stepping motors 108, 109 by driving the stepping motor 110 with a drive pulse having larger energy than drive pulses for driving other stepping motors 108, 109, by setting magnetic resistance of the magnetic core 208 of the stepping motor 110 smaller than magnetic resistance of the magnetic cores 208 of the stepping motors 108, 109 or the like.

Due to such a constitution, according to the third embodiment of the present invention, in the same manner as the above-mentioned embodiments, it is possible to reduce the influence of an external magnetic field exerted on the motor with the simple constitution without using the special dedicated member.

FIGS. 8A and 8B are partial constitutional views of a stepping motor used in an analogue electronic timepiece according to the fourth embodiment of the present invention.

The analogue electronic timepiece of the fourth embodiment is configured such that a drive force of a stepping motor 110 which constitutes a specified motor is set larger than drive forces of stepping motors 108, 109 which constitute other motors by setting the number of turns of a drive coil 209 of the stepping motor 110 larger than the number of turns of drive coils 209 of the stepping motors 108, 109. The number of turns of the drive coil 209 in other motors is small and hence, a portion where the coil 209 is wound around the magnetic core 208 has a small diameter as shown in FIGS. 7A and 7B. On the other hand, the number of turns of the drive coils 209 in the specified stepping motor 110 is large compared to other motors and hence, a portion where the coil 209 is wound around the magnetic core 208 has a large diameter compared to other motors as shown in FIGS. 8A and 8B.

In this manner, the motors 108 to 110 are respectively constituted of the magnet core 208, the coil 209 which is wound around the magnetic core 208, and the rotor 202 which is rotatable based on a magnetic field generated with the supply of an electric current to the coil 209. The stepping motor 110 which constitutes the specified motor is configured to have the larger number of turns of the coil 209 than the number of turns of the coil 209 of the stepping motors 108, 109 which constitute other motors whereby a drive force of the specified motor is set larger than drive forces of other motors.

Accordingly, the analog electronic timepiece of the fourth embodiment of the present invention acquires advantageous effects including an advantageous effect that it is possible to reduce the influence of a magnetic field exerted on the motor with the simple constitution without using the special dedicated member.

Embodiments shown in FIG. 10 to FIG. 12, FIG. 14 and FIG. 15 are examples having the following constitution. Motors 108 to 110 respectively include a magnetic core 208, a coil 209 for driving which is wound around the magnetic core 208, and a rotor 202 which has a circular columnar rotor magnet and is rotated based on a magnetic field generated with the supply of an electric current to the coil 209. The stepping motor 110 which constitutes a specified motor is configured to have a cogging torque smaller than cogging torques of the stepping motors 108, 109 which constitute other motors whereby a drive force of the specified motor is set larger than drive forces of other motors.

In the embodiments shown in FIG. 10 to FIG. 12, the cogging torque of the specified motor is set smaller than the cogging torques of other motors by setting a volume of a rotor magnet of the rotor 202 of the specified motor smaller than volumes of rotor magnets of the rotors 202 of other motors. To be more specific, the volume of the rotor magnet of the rotor of the specified motor can be set smaller than volumes of rotor magnets of the rotors of other motors by performing at least one of setting an outer diameter of the rotor magnet of the rotor of the specified motor smaller than outer diameters of the rotor magnets of the rotors of other motors, setting an inner diameter of the rotor magnet of the rotor of the specified motor larger than inner diameters of the rotor magnets of the rotors of other motors and setting a thickness of the rotor magnet of the rotor of the specified motor smaller than thicknesses of the rotor magnets of the rotors of other motors.

FIG. 10 is a side view showing a rotor of a stepping motor used in an analogue electronic timepiece according to a fifth embodiment of the present invention.

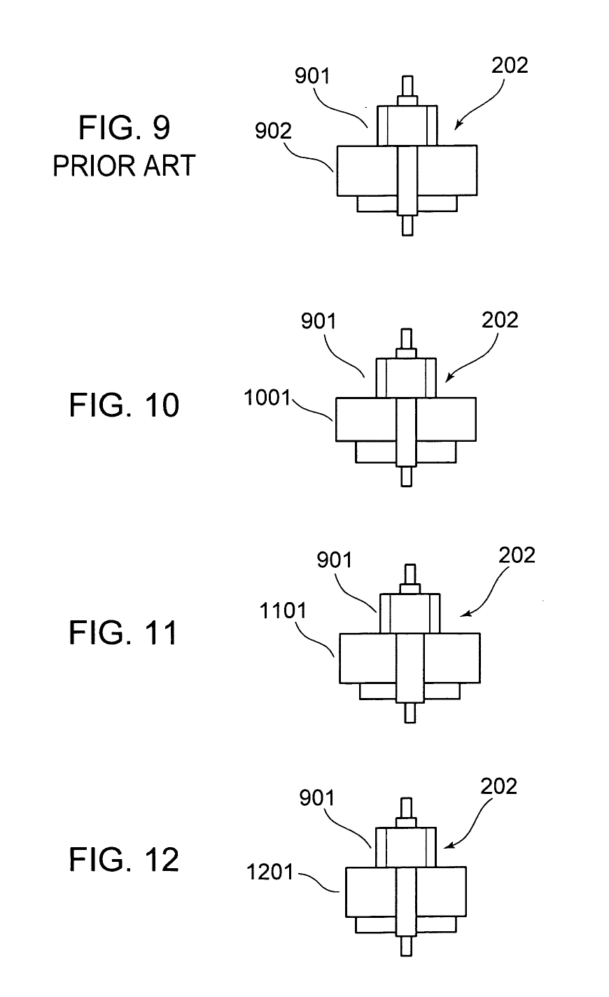

As in the case of the rotor 202 of the conventional stepping motor shown in FIG. 9, a rotor 202 in stepping motors 108, 109 which constitute other motors includes a rotary shaft 901 and a circular columnar rotor magnet 902 mounted on the rotary shaft 901.

In the fifth embodiment shown in FIG. 10, the rotor 202 of the stepping motor 110 which constitutes a specified motor is configured such that a circular columnar rotor magnet 1001 having a smaller thickness compared to the rotor 202 shown in FIG. 9 is mounted on the rotary shaft 901. Due to such a constitution, a cogging torque of the specified motor can be set smaller than cogging torques of other motors.

FIG. 11 is a side view showing a rotor of a stepping motor used in an analogue electronic timepiece according to a sixth embodiment of the present invention.

In the sixth embodiment shown in FIG. 11, a rotor 202 of a stepping motor 110 which constitutes a specified motor is configured such that a circular columnar rotor magnet 1101 having a larger inner diameter (a diameter of a hole through which a rotary shaft 901 passes) compared to the rotor 202 shown in FIG. 9 is mounted on the rotary shaft 901. Due to such a constitution, a cogging torque of the specified motor can be set smaller than cogging torques of other motors.

FIG. 12 is a side view showing a rotor of a stepping motor used in an analogue electronic timepiece according to a seventh embodiment of the present invention.

In the seventh embodiment shown in FIG. 12, a rotor 202 of a stepping motor 110 which constitutes a specified motor is configured such that a circular columnar rotor magnet 1201 having a smaller outer diameter compared to the rotor 202 shown in FIG. 9 is mounted on the rotary shaft 901. Due to such a constitution, a cogging torque of the specified motor can be set smaller than cogging torques of other motors.

The cogging torque of the specified motor may be set smaller than the cogging torques of other motors by forming a rotor magnet using a material having smaller magnet energy (magnetic force) than a material for forming rotor magnets of other motors.

In embodiments shown in FIG. 14 and FIG. 15, a cogging torque of a specified motor is set smaller than cogging torques of other motors by changing a shape of a stator 201.

FIG. 14 is a partial plan view showing a stator 201 of a stepping motor used in an analogue electronic timepiece according to an eighth embodiment of the present invention.

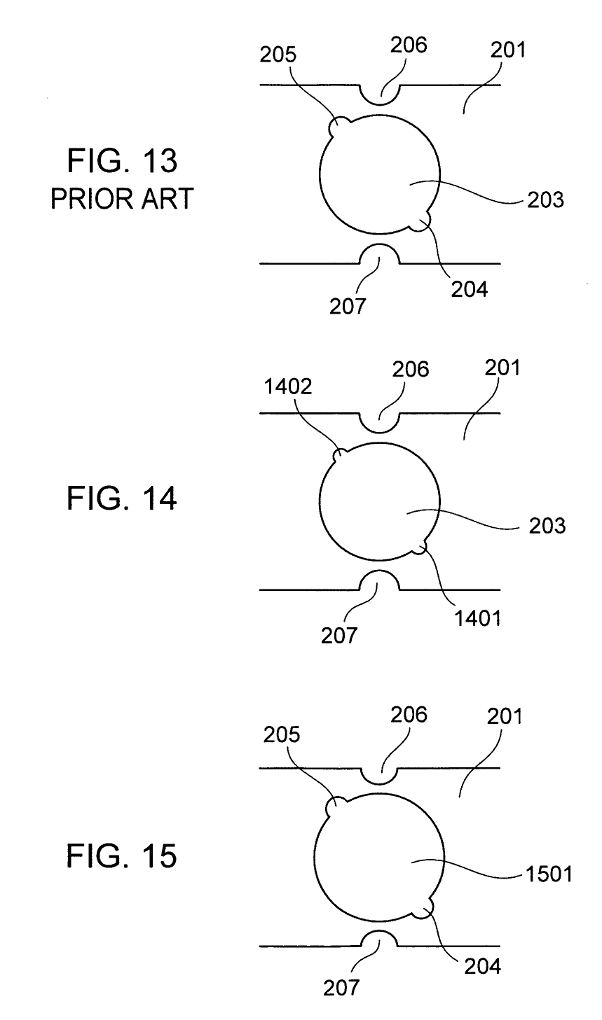

In the same manner as the stator 201 of the conventional stepping motor shown in FIG. 13, the stator 201 in the stepping motors 108, 109 which constitute other motors is connected to the magnetic core 208, and the stator 201 includes a rotor housing through hole 203 which rotatably houses a rotor 202 therein and inner notches 204, 205 for holding the rotor 202 at a predetermined position.

In the eighth embodiment shown in FIG. 14, inner notches 1401, 1402 of a stepping motor 110 which constitutes a specified motor are formed smaller than inner notches (inner notches 204, 205 shown in FIG. 13) of the stepping motors 108, 109 which constitute other motors. Due to such a constitution, a cogging torque of the specified motor is set smaller than cogging torques of other motors.

FIG. 15 is a partial plan view showing a stator 201 of a stepping motor used in an analogue electronic timepiece according to a ninth embodiment of the present invention.

In the ninth embodiment shown in FIG. 15, a rotor housing through hole 1501 formed in a stepping motor 110 which constitutes a specified motor is formed larger than the rotor housing through hole 203 shown in FIG. 13. Due to such a constitution, a cogging torque of the specified motor is set smaller than cogging torques of other motors.

As another embodiment of the present invention, a drive force of the specified motor may be set larger than drive forces of other motors by forming a magnetic core 208 of the specified motor using a material which is magnetically more efficient than a material for forming a magnetic core 208 of other motors.

For example, the magnetic core 208 of the specified motor may be formed using 45% permalloy, and magnetic cores of other motors are formed using 38% permalloy or 42% permalloy. 45% permalloy is a material having larger saturation magnetic flux density or a material having larger permeability compared to 38% permalloy or 42% permalloy. Accordingly, a drive force of the specified motor can be set larger than drive forces of other motors by forming the magnetic core 208 of the specified motor using at least one of a material having large saturation magnetic flux density or a material having large permeability.

By forming the magnetic core 208 of the specified motor using 45% permalloy and forming magnetic cores of other motors using 38% permalloy or 42% permalloy, both the saturation magnetic flux density and permeability can be increased. However, at least one of saturation magnetic flux density and permeability may be increased by suitably selecting a material for forming the magnetic core 208.

Some of the above-mentioned plurality of embodiments may be combined within a range where the embodiments do not contradict each other so that a further enhanced advantageous effect can be obtained by the combination.

In the above-mentioned respective embodiments, the explanation has been made with respect to the example where the stepping motor 110 for driving chronograph hands is used as the specified motor and the stepping motor 109 for driving calendar and the stepping motor 108 for driving time hands are used as other motors. However, motors which can be used as the specified motor and other motors may be selected in accordance with the constitution of an analog electronic timepiece.

In this case, it is often the case that the analog electronic timepiece is temporarily influenced by an external magnetism and hence, a motor whose drive time is short is selected as the specified motor, and a motor whose drive time is long is included in other motors whereby the influence of an external magnetic field exerted on the analog electronic timepiece can be suppressed more effectively.

Further, the explanation has been made with respect to the example where three motors are used in the respective embodiments. However, the present invention is applicable to the analog electronic timepiece having two or more motors.

A pulse width of a drive pulse may be changed for changing energy of the drive pulse or energy of the drive pulse may be changed by forming the pulse per se into a comb-teeth wave and changing ON/OFF duty of the comb-teeth wave, changing a pulse voltage or the like.

The electronic timepiece according to the present invention is applicable to an analog electronic timepiece having a plurality of motors such as an analog electronic timepiece having a calendar function and a chronograph timepiece.

What is claimed is:

1. An analogue electronic timepiece where a plurality of motors which rotatably drive a plurality of indication members are mounted on a movement, wherein
the timepiece comprises a magnetic member through which an external magnetic field passes besides the plurality of motors, and
a specified motor is arranged such that a larger amount of external magnetic field passes through the specified motor than another motor via the magnetic member, and a drive force of the specified motor is set larger than a drive force of said another motor.

2. The analogue electronic timepiece according to claim 1, wherein drive energy of the specified motor is set larger than drive energy of said another motor.

3. The analogue electronic timepiece according to claim 2, wherein the timepiece further comprises:
a magnetic field detection means which detects a magnetic field; and
a control means which performs a control so as to set the drive energy of the specified motor larger than the drive energy of said another motor when the magnetic field detection means detects a magnetic field having predetermined intensity or more.

4. The analogue electronic timepiece according to claim 1, wherein each motor includes a magnetic core, a drive coil which is wound around the magnetic core, and a rotor which is rotated based on a magnetic field generated with the supply of an electric current to the drive coil, wherein
a drive force of the specified motor is set larger than a drive force of said another motor by setting magnetic resistance of the magnetic core of the specified motor smaller than magnetic resistance of the magnetic core of said another motor.

5. The analogue electronic timepiece according to claim 4, wherein the magnetic resistance of the magnetic core of the specified motor is set smaller than the magnetic resistance of the magnetic core of said another motor by setting a cross-sectional area of the magnetic core of the specified motor larger than a cross-sectional area of the magnetic core of said another motor.

6. The analogue electronic timepiece according to claim 4, wherein the magnetic resistance of the magnetic core of the specified motor is set smaller than the magnetic resistance of the magnetic core of said another motor by setting a length of the magnetic core of the specified motor shorter than a length of the magnetic core of said another motor.

7. The analogue electronic timepiece according to claim 1, wherein each motor includes a magnetic core, a drive coil which is wound around the magnetic core, and a rotor which is rotated based on a magnetic field generated with the supply of an electric current to the drive coil, wherein
a drive force of the specified motor is set larger than a drive force of said another motor by setting the number of turns of the drive coil of the specified motor larger than the number of turns of the drive coil of said another motor.

8. The analogue electronic timepiece according to claim 1, wherein each motor includes a magnetic core, a drive coil which is wound around the magnetic core, and a rotor which has a columnar rotor magnet and is rotated based on a magnetic field generated with the supply of an electric current to the drive coil, wherein
a drive force of the specified motor is set larger than a drive force of said another motor by setting a cogging torque of the specified motor smaller than a cogging torque of said another motor.

9. The analogue electronic timepiece according to claim 8, wherein the cogging torque of the specified motor is set smaller than the cogging torque of said another motor by setting a volume of the rotor magnet of the specified motor smaller than a volume of the rotor magnet of said another motor.

10. The analogue electronic timepiece according to claim 9, wherein the volume of the rotor magnet of the specified motor is set smaller than the volume of the rotor magnet of said another motor by carrying out at least one of setting an outer diameter of the rotor magnet of the specified motor smaller than an outer diameter of the rotor magnet of said another motor, setting a thickness of the rotor magnet of the specified motor smaller than a thickness of the rotor magnet of said another motor and setting an inner diameter of a hole formed in the rotor magnet of the specified motor through which a rotary shaft passes larger than an inner diameter of a hole formed in the rotor magnet of said another motor through which a rotary shaft passes.

11. The analogue electronic timepiece according to claim 8, wherein the cogging torque of the specified motor is set smaller than the cogging torque of said another motor by forming the rotor magnet of the specified motor using a material having smaller magnetic energy than a material for forming the rotor magnet of said another motor.

12. The analogue electronic timepiece according to claim 1, wherein each motor includes a magnetic core, a drive coil which is wound around the magnetic core, a stator which is connected to the magnetic core and has a rotor housing through hole for housing the rotor in a rotatable manner and a notch for holding the rotor at a predetermined position, and the rotor which is rotated based on a magnetic field generated with the supply of an electric current to the drive coil, wherein
a cogging torque of the specified motor is set smaller than a cogging torque of said another motor by setting the notch of the specified motor smaller than the notch of said another motor thereby a drive force of the specified motor is set larger than a drive force of said another motor.

13. The analogue electronic timepiece according to claim 1, wherein each motor includes a magnetic core, a drive coil which is wound around the magnetic core, a stator which is connected to the magnetic core and has a rotor housing through hole for housing the rotor in a rotatable manner and a notch for holding the rotor at a predetermined position, and the rotor which is rotated based on a magnetic field generated with the supply of an electric current to the drive coil, wherein
a cogging torque of the specified motor is set smaller than a cogging torque of said another motor by setting the rotor housing through hole formed in the stator of the specified motor larger than the rotor housing through hole formed in the stator of said another motor thereby a drive force of the specified motor is set larger than a drive force of said another motor.

14. The analogue electronic timepiece according to claim 1, wherein each motor includes a magnetic core, a drive coil which is wound around the magnetic core, and a rotor which is rotated based on a magnetic field generated with the supply of an electric current to the drive coil, wherein
a drive force of the specified motor is set larger than a drive force of said another motor by forming the magnetic core of the specified motor using a material which is magnetically more efficient than a material for forming the magnetic core of said another motor.

15. The analogue electronic timepiece according to claim 14, wherein
the drive force of the specified motor is set larger than the drive force of said another motor by forming the magnetic core of the specified motor using a material which is superior to a material for forming the magnetic core of said another motor with respect to at least one of saturation magnetic flux density and permeability.

16. The analogue electronic timepiece according to claim 1, wherein the specified motor is directly connected to the magnetic member or is indirectly connected to the magnetic member via a magnetic material.

17. The analogue electronic timepiece according to claim 1, wherein the specified motor is arranged closer to the magnetic member than said another motor.

18. The analogue electronic timepiece according to claim 1, wherein the magnetic member is a battery can formed using a magnetic material.

19. The analogue electronic timepiece according to claim 1, wherein the magnetic member is a circuit pressing piece which is formed of a magnetic material.

20. The analogue electronic timepiece according to claim 1, wherein the specified motor is not a motor which is always driven, and said another motor includes a motor which is always driven.

21. The analogue electronic timepiece according to claim 20, wherein the indication member which the specified motor rotatably drives is a chronograph hand or a calendar, and the indication member which is driven by said another motor which is always driven is a time hand.
